(19) United States
(12) Patent Application Publication
(10) Pub. No.: US 2023/0277995 A1
(43) Pub. Date: Sep. 7, 2023

(54) MINERAL HYDROGELS FROM INORGANIC SALTS

(71) Applicant: City University of Hong Kong, Hong Kong (HK)

(72) Inventors: Jian LU, Hong Kong (HK); Yang Yang LI, Hong Kong (HK); Bo LI, Hong Kong (HK); Zhengtao XU, Hong Kong (HK); Jiahua LIU, Hong Kong (HK)

(21) Appl. No.: 17/685,351

(22) Filed: Mar. 2, 2022

(51) Int. Cl. B01J 13/00

(52) U.S. Cl. CPC B01J 13/0056

(57) ABSTRACT

A method for making inorganic mineral hydrogels is provided. In one aspect, a first solution including one or more metal cations from one or more inorganic precursors is used. The metal cations are one or more of Fe, Mg, Ca, Co, Ni, Zn, Ti, Cu, Sn, or Mn. A second solution includes one or more polyoxometalates of Mo, W, V, Nb, or Ta. The first and second solutions are mixed together to form the inorganic mineral hydrogel. In one example, an aqueous solution of ferric chloride hexahydrate (FeCl₃·6H₂O) is mixed with an aqueous solution of ammonium molybdate tetrahydrate ((NH₄)₆Mo₇O₂₄·4H₂O), under ambient conditions. The two reactants first form a yellow precipitate (FeMo₂Oₓ(OH)_{y}), which subsequently dissolves back into the solution to gradually produce a viscous hydrogel that traps a large volume of water.

### FIELD OF THE INVENTION

The present invention relates to mineral hydrogels and, more particularly to mineral hydrogels that may be fabricated from inorganic salts.

### BACKGROUND

Gels are a type of soft solid-like material in which a liquid phase is immobilized within the interstitial spaces of a host cross-linked network. Gels can be divided into organogels and hydrogels, according to the nature of the liquid phase: if the liquid phase is organic (e.g., an ionic liquid or a deep eutectic solvent), the gel is called an organogel; if the liquid phase is aqueous, a hydrogel. The host networks are generally organic for both organogels and hydrogels; the networks are made up of organic polymers or organic molecules. As such both organogels and hydrogels are mostly “organic gels.” Despite their many potential applications (e.g., in biosensing, drug delivery, energy storage, and tissue engineering), organic gels exhibit poor ionic conductivity and have other drawbacks. These drawbacks may be partly remedied by using specialized components. For example, to improve ionic conductivity, ionic liquids or deep eutectic solvents (based on choline chloride and polyalcohols) can be gelated to form ionogels and eutectogels, respectively.

Organic gels often undergo large volume expansion when immersed in solutions, compromising gel stability as well as mechanical strength. To reduce undesired swelling, sophisticated designer gel systems have been created, including double network hydrogels and multiple network organohydrogels. Despite these important advances, organic gels generally suffer from low thermal stability, high flammability, vulnerability to photodamage, and fabrication shortcomings involving toxic organic solvents.

In comparison, all-inorganic, mineral gels may potentially remediate the disadvantages of conventional organic gels. Inorganic gels may exhibit a strong ionic character; as such, inorganic gels may be able to better accommodate mobile ionic additives (e.g., LiCl; to boost conductivity), as well as transition metal salts to impart a greater variety of chemical functionalities (e.g., for catalysis or energy storage). The relatively stiff and stable inorganic framework of potential inorganic gels may be less prone to swelling and burning, while offering more resistance against photo-damage and thermal degradation. Further, the inorganic precursors for inorganic mineral gels tend to be more compatible with water-based fabrication protocols, thereby facilitating green syntheses that are low-cost, non-toxic and environmentally friendly.

Mineral gels from purely inorganic components are, however, rare. This is because inorganic frameworks tend to be rigid, unyielding structures, and it is difficult to impart the porous and flexible character that is requisite for gelation. In fact, most of the inorganic gels (including silica-based gels and chalcogels) reported to date have been made by sol-gel reactions of metal alkoxides and alcohol/water solutions, with the organic residues from the reaction often left in the gel products. The first inorganic gel synthesized from a completely inorganic route was based on AgVO₃ by using AgNO₃ and NH₄VO₃. Another strictly inorganic gel is a TiO₂-based gel, where TiCl₄ is used as a precursor compound. However, vanadate salts are toxic and TiCl₄ is corrosive; therefore, gels involving these precursors are problematic in terms of fabrication and are not biocompatible.

Thus, there is a need in the art for improved mineral hydrogels and improved fabrication of mineral hydrogels. The present invention addresses this need.

### SUMMARY OF THE INVENTION

The present invention relates to methods for making inorganic mineral hydrogels and the hydrogels produced by the methods. In one aspect, a first solution including one or more metal cations from one or more inorganic precursors is used. The metal cations are one or more of Fe, Mg, Ca, Co, Ni, Zn, Ti, Cu, Sn, or Mn. A second solution includes one or more polyoxometalate of Mo, W, V, Nb, or Ta. The first and second solutions are mixed together to form the inorganic mineral hydrogel.

In one example, an aqueous solution of ferric chloride hexahydrate (FeCl₃·6H₂O) is mixed with an aqueous solution of ammonium molybdate tetrahydrate ((NH₄)₆Mo₇O₂₄·4H₂O), under ambient conditions. The two reactants first form a yellow precipitate (FeMo₂Oₓ(OH)_{y}), which subsequently dissolves back into the solution to gradually produce a viscous hydrogel that traps a large volume of water (Scheme 1 a). The inorganic mineral gel can be readily divided into fragments; alternatively, fragments can be merged seamlessly, indicating its potential to enable cell division and fusion (Scheme 1b).

### BRIEF DESCRIPTION OF THE DRAWINGS

FIG. 1 is a schematic illustration of the synthetic route of the mineral gels reported in this study (a), the optical photographs of two pieces of the mineral gel before and after merged into one (b), and their general characteristics in comparison with organic hydrogels and organogels (c).

FIGS. 2A-2C are photographs of “Gel-0.5M” (a), “Gel-1M” (b), both trapping 20 mL water which was approximately 6 times of the gel dry weight and a self-stand “Gel-1M” sample holding a weight of 0.2 kg (c).

FIGS. 3A-3E show SEM images of “Paste-0.1M” (FIG. 3A), “Gel-0.5M” (FIG. 3B), and “Gel-1M” (FIG. 3C) with the corresponding photographs shown in the insets. The scale bars indicate 500 nm. Plots of G′ (storage moduli) and G″ (loss moduli) vs. shear frequency for “Gel-0.5M” are shown in FIG. 3D and “Gel-1M” (FIG. 3E).

FIG. 4 shows x-ray diffraction patterns of freeze-dried “Paste-0.1M”, “Gel-0.5M”, and “Gel-1M”.

FIGS. 5A-5B are TG/DSC curves of “Paste-0.1M” (5A) and “Gel-1M” (5B).

FIG. 6 is a plot of G′ and G″ for paste 0.1M.

FIGS. 7A-7D are Raman spectra of “Paste-0.1M”, “Gel-0.5M”, and “Gel-1M” (7A). The deconvoluted curves at the high-wavenumber region is shown in (7B). High-resolution O 1s (7C) and Fe 2p (7D) XPS spectra of “Paste-0.1M” and “Gel-1M”.

FIGS. 8A-8B show high-resolution Mo 3d XPS spectra of “Paste-0.1M” (8A) and “Gel-1M” (8B).

FIGS. 9A-9B show a CV study at a scan rate of 50 mV s⁻¹ of a 1 M NaCl aqueous solution (9A) and “Gel-1M” with 1 M NaCl (9B).

FIG. 10 shows x-ray diffraction patterns of the yellow precipitate and its crystalline phase. Insets show the corresponding elemental contents.

FIG. 11 is the x-ray diffraction pattern of the “paste-0.1M” after being thermally annealed at 350° C. for 2 hr.

FIGS. 12A-12C shows the growth status of MRC-5 cells incubated in media containing different concentrations of gels for 72 h: morphology, scale bar represents 100 μm (12A) and the cell viability (12B). FIG. 12C shows the mass change of “Gel-1M” when soaked in water for 60 days. Inset: photographs of the gel that was freshly prepared and after immersion in water for 60 days.

FIG. 13 shows photographs of “Gel-1M” containing various metal ionic additives.

FIGS. 14A-14B shows a Nyquist plot of the blank “Gel-1M” and “Gel-1M” containing different ionic additive (0.5 M) (14A) and the corresponding ionic conductivities (14B).

FIGS. 15A-15F show the electrochemical performance of the all-in-one mineral hydrogel capacitor: FIG. 15A-15B show cyclic voltammetry curves and the corresponding volumetric capacitances and energy densities at different scan rates; FIGS. 15C-15D show galvanostatic charge/discharge profiles and the corresponding volumetric capacitances; FIG. 15E shows a Nyquist plot in the frequency range of 0.1 to 10⁵ Hz; FIG. 15F shows galvanostatic charge/discharge cyclic performance over 5000 cycles at 46 mA cm⁻² (the insets showing first and last five cycles).

FIG. 16A-16B are cyclic voltammetry curves at the scan rates of 100-300 mV s⁻¹ (16A) and galvanostatic charge/discharge profiles at the current densities of 13-37 mA cm⁻² (16B) of the mineral hydrogel capacitor.

FIG. 17 is a Ragone plot of a mineral hydrogel capacitor compared to several commercial energy-storage systems and devices based on MoS₂, black P, and ECG/CNT.

### DETAILED DESCRIPTION

The present invention provides a method for making an inorganic mineral hydrogel. In the method, a first solution including one or more metal cations from one or more inorganic precursors is mixed with a second solution that includes one or more polyoxometalates. The resultant mixture forms an inorganic mineral hydrogel. The polyoxometalate typically includes three or more transition metal oxyanions. Because they are linked together with shared oxygen atoms, three-dimensional networks can be formed. In particular, heteropolymetalates may be used in the second precursor solutions of the present invention. Heteropolymetalates include heteroatoms in addition to the transition metal atom. In particular, the heteropolymetalates anion of the present invention may include at least one metal oxide selected from an oxide of Mo, W, V, Nb or Ta. The second solution may include a molybdate, tungstate, chloride, carbonate, phosphate, hydrogen phosphate, hydroxide or acetate anions.

In general, a ratio of the metal cation in the first solution to a metal component of the polyoxometalate in the second solution is from 1:2 to 1:1.

In an embodiment, quaternary ammonium salts of polyoxometalates may be used in the second solution. An example of a quaternary ammonium salt of a polyoxometalate that may be used in the second solution is ammonium molybdate tetrahydrate, (NH₄)₆Mo₇O₂₄·4H₂O.

The first solution may contain a metal cation selected from one or more of Fe, Mg, Ca, Co, Ni, Zn, Ti, Cu, Sn, or Mn ions. These metal cations may be from the dissociation of a metal salt. In one embodiment, Fe is selected as the metal cation. In particular, an aqueous solution of ferric chloride hexahydrate (FeCl₃·6H₂O) may be used as the first metal cation-containing solution.

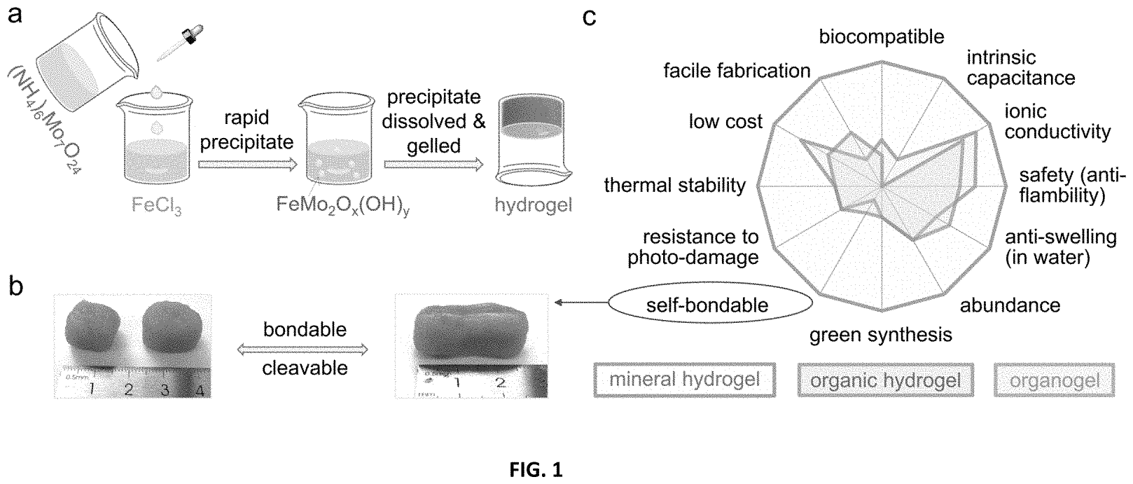

The reaction of ferric chloride hexahydrate (FeCl₃·6H₂O) with ammonium molybdate tetrahydrate, (NH₄)₆Mo₇O₂₄·4H₂O first forms a yellow precipitate (FeMo₂Oₓ(OH)_{y}) which subsequently dissolves back into the solution to gradually produce a viscous hydrogel that traps a large quantity of water (Scheme 1a of FIG. 1). The inorganic mineral gel can be readily divided into fragments; alternatively, fragments can be merged seamlessly, indicating its potential to enable cell division and fusion (Scheme 1b).

The first and second solutions are aqueous solutions. Optionally, an organic solvent may be included. Examples of organic solvents that may be included are ethanol, acetone, dimethylformamide, dimethyl sulfoxide, or carbonate solvents or mixtures thereof.

To alter the conductivity of the mineral hydrogel, the first and/or second solutions may include an ionic liquid. Examples of ions which may be included are Li⁺, Na⁺, K⁺, Ca²⁺, Mg²⁺, Zn²⁺, Mn²⁺ and mixtures thereof.

The hydrogels formed from the above reactions are self-healable (FIG. 1—Scheme 1b), and display superior stability against disintegration and expansion, showing no collapse or volume expansion over extended soaking in water. Compared to other gels (organic hydrogel and organogel), the mineral hydrogels of the present invention demonstrate advantages in terms of raw materials, cost-effectiveness, production efficiency, synthetic route, and charge storage ability (FIG. 1—Scheme 1c).

Due to their unique properties, the inorganic mineral hydrogels of the present invention have a wide variety of applications. The inorganic mineral hydrogels may be used in supercapacitors. When ion additives are employed (Li⁺, Na⁺, K⁺, Ca²⁺, Mg²⁺, Zn²⁺, Mn²⁺), the resultant ion-laden gels possess high ionic conductivity. For gels that are the reaction product of ferric chloride hexahydrate (FeCl₃·6H₂O) with ammonium molybdate tetrahydrate, (NH₄)₆Mo₇O₂₄·4H₂O, the redox pair (Fe²⁺/Fe³⁺) in the framework of the gel imparts considerable pseudo-capacitance.

For traditional supercapacitors, tuning the porosity of the fabric to incorporate more activated material to enhance electric double-layer capacitance, using metal oxide as an electrode material or a redox-active electrolyte to increase Faradaic capacitance, are the main strategies to improve their energy storage capacity. In contrast, the inherent redox ion pairs in the gel framework of the inventive hydrogels and their high ionic conductivity make it possible to both provide Faradaic capacitance and act as an ionic conductor, eliminating the need for a separator between positive and negative electrodes, to create an all-in-one supercapacitor. This all-in-one mineral hydrogel capacitor also delivers high volumetric energy density (7.8 mWh cm⁻³, comparable with a 500-μAh lithium thin-film battery, and three orders of magnitude that of a 3 V/300 mF aluminum electrolytic capacitor) and power density (over a hundred times that of the lithium thin-film battery), rivaling several devices based on conventional materials (e.g., MoS₂, black phosphorus, and exfoliated graphene/carbon nanotube (ECG/CNT)). The mineral hydrogels of the present invention may alleviate the issues regarding the poor energy density of conventional supercapacitors.

### EXAMPLES

### Synthesis of “Paste-0.1M”

The molar ratio of Fe to Mo in the precursor solutions was set as 1:1. FeCl₃·6H₂O (0.002 mole or 0.54 g) and (NH₄)₆Mo₇O₂₄·4H₂O (0.002/7 mole or 0.353 g) were separately dissolved each in 20 mL of deionized water (DI water). The (NH₄)₆Mo₇O₂₄ solution was dropwise added to the FeCl₃ solution under magnetic stiffing, after which the mixed solution was stirred for another 30 minutes, resulting in a yellow suspension. The suspension was centrifuged at 9000 rpm for 3 minutes. After decanting the upper water layer, a paste product was obtained at the bottom of the centrifuge tube. The paste was washed by adding to the tube another 40 mL of DI water, shaking for dozens of times, centrifuging at 9000 rpm for 3 min, and then decanting the upper water layer. The above washing steps were further repeated twice to produce a sample of “Paste-0.1M”.

### Synthesis of “Gel-0.5M”

Having the molar ratio of Fe:Mo kept at 1:1, 0.005 mole FeCl₃·6H₂O (1.35 g) and (0.005/7) mole (NH₄)₆Mo₇O₂₄·4H₂O (0.883 g) were separately dissolved each in 10 mL of DI water with a stirring bar, then the (NH₄)₆Mo₇O₂₄ solution was dropwise added to the FeCl₃ solution under magnetic stirring—the order of solution addition is important for producing gels. During the addition process, a yellow precipitate was first generated and then dissolved in the solution, while the solution gradually became more viscous and, after 40 minutes, completely turned into a homogeneous yellow green gel which is termed “Gel-0.5M”. There was no left-over liquid phase after the gelation process.

### Synthesis of “Gel-1M”

The synthesis procedure of “Gel-1M” was identical to “Gel-0.5M”, except that doubly concentrated precursor solutions of FeCl₃·6H₂O (1 M) and (NH₄)₆Mo₇O₂₄·4H₂O (1/7 M) were used (the molar ratio of Fe:Mo was still 1:1). A stiffer gel was obtained 30 min after the two precursor solutions were mixed under magnetic stiffing, which was denoted as “Gel-1M”. There was no left-over liquid phase after the gelation process.

### Synthesis of Metal Ion-Incorporated Mineral Gels

The metal ion-incorporated gels were synthesized using the same procedure as “Gel-1M”, except that a metal ionic additive (0.5 M) was included in the precursor solution of (NH₄)₆Mo₇O₂₄·4H₂O, that is, 0.01 mole of salt (NaCl, LiCl, ZnCl₂, CaCl₂·2H₂O, MnCl₂, or MgCl₂·6H₂O) was added into the precursor solution that was prepared by dissolving (0.01/7) mole of (NH₄)₆Mo₇O₂₄·4H₂O into 10 mL DI water. The presence of the metal ionic additives did not affect the formation of the mineral gels, e.g., the gelation time remained to be around 30 min.

### Fabrication of Mineral Hydrogel Capacitor

The mineral hydrogel for constructing the supercapacitor was synthesized similarly to the above-mentioned “Gel-1M”, except with a doubly concentrated precursor solutions of FeCl₃·6H₂O (2 M) and (NH₄)₆Mo₇O₂₄·4H₂O (2/7 M) and 1 M NaCl as the ionic additive. After mixing the precursor solutions for ˜5 mins, a stiffer gel with 1 M NaCl was formed. By sandwiching the thus-obtained gel in between two pieces of carbon cloth, a facile all-in-one mineral hydrogel capacitor was formed.

### Characterizations

Field-emission scanning electron microscope (Philips XL-30 FESEM) equipped with an energy-dispersive X-ray spectroscope (EDS) (Apollo X) was used to characterize morphology and element contents. The thermogravimetric/differential scanning calorimetry (TG-DSC) analysis was carried out on a DSC Q20 Differential calorimeter. X-ray photoelectron spectroscopy (XPS) measurements were performed on a VG ESCALAB 220iXL X-ray photoelectron spectrometer using a monochromatic Al K_{α} X-ray beam (1486.6 eV). A Kinexus Lab+ Rotational Rheometer was used to investigate the rheological behaviors, and the plots of modulus vs. shear frequency were recorded at 25° C. with a shear strain of 0.1% from 0.1 to 100 HZ. The Raman spectra were collected on WITec RAMAN alpha 300R equipped with a 532 nm excitation laser. X-ray diffraction (XRD) patterns were obtained on an X-ray diffractometer (Rigaku SmartLab) in a 2theta range from 15 to 65° with Cu K_{α} radiation. The morphology of MRC-5 cells was observed under a Nikon Ts2 inverted microscope, and the cell viability was measured by a Molecular Devices SpectraMax ID5 Microplate Reader. The cyclic voltammetry (CV), galvanostatic charge/discharge (GCD) and electrochemical impedance spectroscopy (EIS) were measured by a CHI 660E potentiastat. The GCD cycles were recorded on an Autolab (PGSTAT302N) electrochemical workstation.

### In Vitro Cytotoxicity Study of the Mineral Hydrogel

The cytotoxicity of the hydrogel system was investigated using the 3-(4,5-dimethylthiazol-2-yl)-2,5-diphenyltetrazolium bromide (MTT) assay. Briefly, MRC-5 human lung fibroblast cells (4,000 cells per well) were cultured in the 96-wells plates for 48 h. Then the culture medium was removed, cells were washed with PBS (pH 7.4) twice and cultured with medium containing 0, 0.05, 0.1, 0.2, and 0.5 wt. % of mineral hydrogel (“Gel-1M”) for 72 h. Next, the culture medium was replaced with fresh medium containing 1 mg/mL MTT. After 2 h incubation, the culture medium was removed, 150 μL DMSO were added into each well. The plate was placed on a shaker to shake at 50 rpm for 15 min, then the absorption of 570 nm and 630 nm were measured by a microplate reader. The mineral hydrogel (“Gel-1M”) used for the cytotoxicity test was pre-soaked in water for 1 week with daily water changes.

### Cell Lines and Cell Culture Conditions

MRC-5 cells (human lung fibroblast) were maintained in Minimum Essential Media (MEM) with 10% Fetal Bovine Serum (FBS), 1% L-glutamine, 1% Non-Essential Amino Acid (NEAA), and 1% sodium pyruvate.

### Electrochemical Impedance Spectroscopy (EIS) Measurements

The gel EIS measurement was conducted using a sandwiched Pt/Gel/Pt configuration on the CHI660E potentiostat under the open-circuit conditions with the voltage amplitude of 5 mV and a frequency range of 0.1-10⁵ Hz. The ionic conductivity (σ) was determined as:

σ=L/R_{b}A

where L is the gel thickness (0.5 cm), A the area of the gel tested (1.5 cm×1 cm), and R_{b} the bulk resistance of the gel.

### Electrochemical Performance Test of the Mineral Hydrogel Capacitor

The charge storage ability of this mineral hydrogel capacitor was measured in a three-electrode electrochemical cell, where two carbon rods with a diameter of 6 mm and a saturated calomel electrode were inserted into the mineral hydrogel. The distance between the two carbon rods was 1 mm, and the depth of the carbon rod into the gel was 1 cm, so the active area involved in the electrochemical reaction was 1.884 cm², and the effective volume of the gel used for this all-in-one supercapacitor was 0.1884 cm³. The volumetric capacitance and energy density in this work was calculated based on the volume of the entire all-in-one hydrogel capacitor.

The volumetric capacitance (C, unit: F g⁻¹) based on the CV curves at different scan rates was calculated according to the following equation:

$$a . \qquad C = \frac{1}{2 VU υ} {\int }_{{u}_{1}}^{{u}_{2}} I ( u ) du$$

Where U is the potential window, υ is the scan rate, and V is the effective volume of this all-in-one hydrogel capacitor. The volumetric capacitance at different current densities was estimated as following:

$$a . \qquad C = \frac{I Δ t}{VU}$$

where I is the current density, Δt the discharge time, and U the operating potential range. The volumetric energy density (E, in Wh cm⁻³) and power density (P, in W cm⁻³) in the Ragone plot were evaluated as: E=0.5 CU²/3600; P=E×3600/Δt.

### Results

### Overview

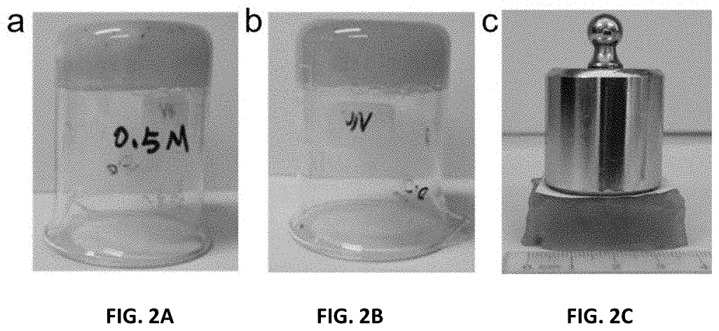

The mineral hydrogel was synthesized using a simple and effective method, without using any organic metal salts or other organic compounds; the water solutions of the inorganic salts of FeCl₃·6H₂O and (NH₄)₆Mo₇O₂₄·4H₂O were mixed. In one example, a fixed ratio of Fe to Mo was selected to be 1:1 in the precursor solution; when the concentration of FeCl₃·6H₂O reached 0.5 M, a pistachio-colored gel with no fluidity (marked as “Gel-0.5M”) was obtained as shown in FIG. 2A. A stiffer gel was produced with a higher FeCl₃·6H₂O concentration (e.g., 1 M, with the corresponding gel product denoted as “Gel-1M”, FIG. 2B), also, the gel can self-stand without a glass vessel and stand 2 N gravity without any deformation (FIG. 2C). In contrast, no gel formation occurs but instead a yellow suspension that turned into a paste after centrifugation resulted when a less concentrated FeCl₃·6H₂O solution was used (e.g., 0.1 M, with the corresponding paste product labeled as “Paste-0.1M”).

### Characterizations of the Mineral Hydrogel

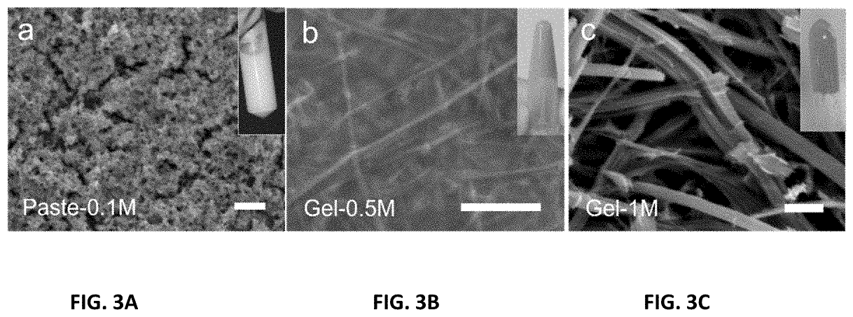

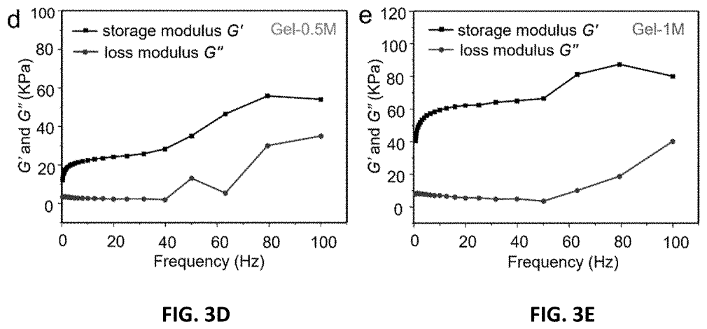

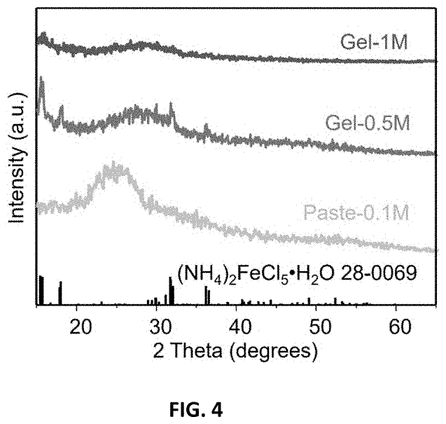

SEM observation confirmed the morphological difference between the paste and gel products (FIGS. 3A-3C): evenly dispersed nanoparticles ranging from 20 to 60 nm were observed for “Paste-0.1M”, however, nanowires with different diameters were observed for “Gel-0.5M” and “Gel-1M” (FIGS. 3B and 3C), and it is these networks of entangled nanofibers that contribute to the formation of a gel with a better mechanical property. The as-synthesized paste and gel samples were freeze-dried, and the resultant powders were measured in x-ray diffraction (FIG. 4). The broad diffraction humps unveiled their structural disorder, whereas a set of weak peaks attributed to (NH₄)₂FeCl₅·H₂O was observed on “Gel-0.5M” and “Gel-1M”, implying (NH₄)₂FeCl₅H₂O was generated during the gelation process.

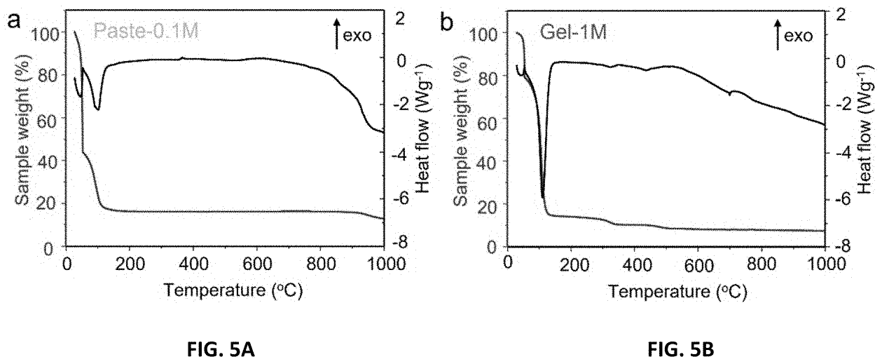

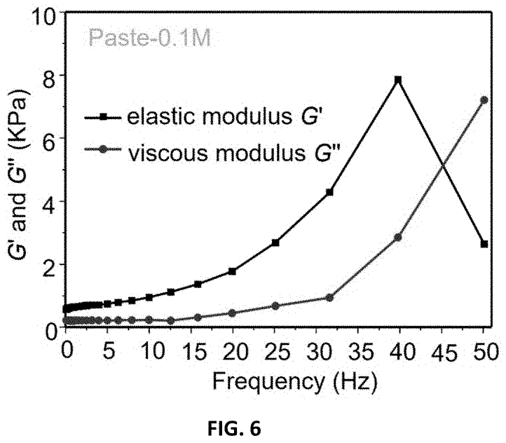

Thermal analysis of TG/DSC measurements of “Paste-0.1M” showed an apparent endothermic peak around 100° C. accompanied with 85% weight loss, which was attributed to the evaporation of free water (FIG. 5A). “Gel-1M” (FIG. 5B) also lost 85% weight around 110° C. due to water evaporation, indicating the gel's capability to accommodate a large amount of water nearly 6 times of its own dry weight. Regarding rheological properties (FIG. 3D and FIG. 3E), both “Gel-1M” and “Gel-0.5M” possessed an elastic modulus (G′) greater than the loss modulus (G″) in a large shear frequency range to at least 100 Hz, confirming their solid-like behaviors. By contrast, a loss modulus larger than its elastic modulus was observed for “Paste-0.1M” above 40 Hz (FIG. 6), revealing the structural breakdown analogous to the response of a liquid under high shear frequencies. Besides, G′ of “Gel-1M” and “Gel-0.5M” were much larger than “Paste-0.1M”, indicating their higher stiffness. These observations further confirmed that “Gel-0.5M” and “Gel-1M” behaved more like a solid with mild rigidity while containing very high water contents, i.e., they are gels, more specifically, hydrogels.

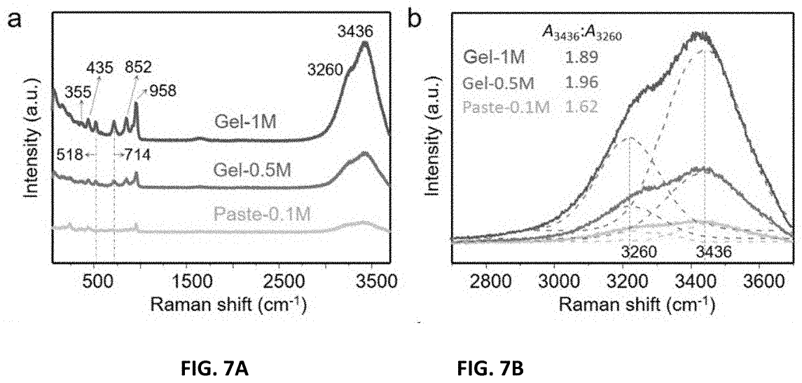

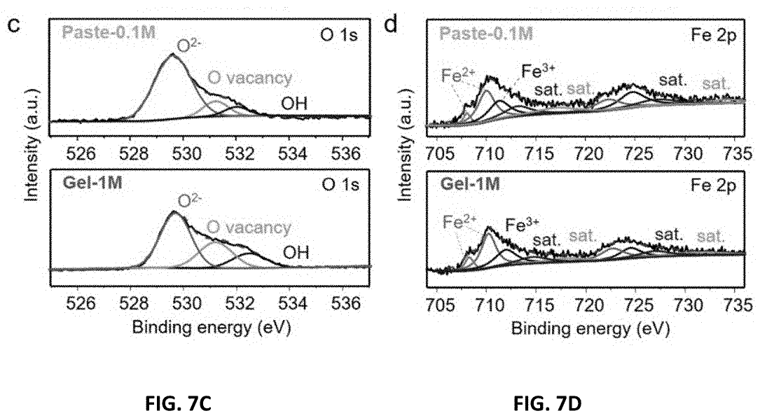

Raman characterizations further revealed the difference, particularly in the hydroxide group and hydration state, between the paste and gel products. Although similar spectral features in the low-wavenumber region were observed on both the paste and the gel samples (435 cm⁻¹ assigned to the Fe—O vibrations, 852 and 958 cm⁻¹ to the stretching vibrations of MoO₄, and 355 cm⁻¹ to the bending vibration of MoO₄), the peaks attributed to Fe³⁺O(OH) (at 518 and 714 cm⁻¹) were present only for “Gel-0.5M” and “Gel-1M” (FIG. 7A). Regarding the high-wavenumber regime, two peaks centered at 3260 and 3436 cm⁻¹ were detected, which respectively represent the strongly and weakly hydrogen-bonded components of water molecules. More specifically, the band at 3260 cm⁻¹ is assigned to the in-phase O—H stretching vibrations of an H-bonded aggregate formed between a central H₂O molecule and its neighbor water molecules, while peak at 3436 cm⁻¹ corresponds to the O—H stretch of partially H-bonded water that has lost phase correlation with its neighbors.^{[38-39]} A careful comparison of the areal ratio of the peak at 3436 cm⁻¹ to the peak at 3260 and cm⁻¹ (A₃₄₃₆:A3260) revealed a distinct variance between the paste and gel samples (FIG. 7B): the gels exhibited significantly higher ratios of A₃₄₃₆:A3260 than the paste, suggesting their larger portion of water molecules whose nearest neighbors are not purely water molecules. This observation indicated the H-bond network of water in the gel system was partially disbanded with water trapped in the fine microframeworks made from the re-dissolved precipitates and other ions (e.g., NH₄⁺).

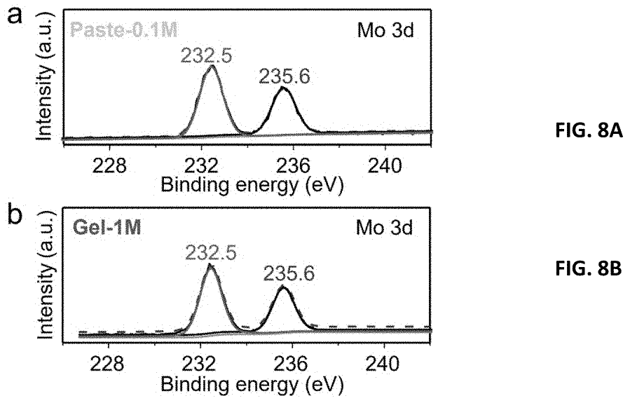

The XPS analysis revealed the existence of the hydroxyl group and Fe²⁺/Fe³⁺ redox pair in “Paste-0.1M” and “Gel-1M”. The O 1s spectral feature was deconvoluted into three peaks, lattice oxygen (O²⁻) in metal oxide at 529.8 eV, 0 vacancy at 531.2 eV, and the hydroxy group at 532 eV (FIG. 7C). A higher peak areal ratio of the hydroxy group and O vacancy to the total peaks was observed on “Gel-1M” than “Paste-0.1M”. The Fe 2p XPS spectra of “Paste-0.1M” and “Gel-1M” (FIG. 7D) displayed spectral features of Fe²⁺ and Fe³⁺ and their satellite peaks: 707.7, 710.2, and 723 eV for Fe²⁺ with a pair of satellite signals at 715.0 and 728 eV; 712.0 and 725.0 eV for Fe³⁺ with a pair of satellite peaks at 718.9 and 732 eV. This observation confirms that the gel framework possessed Fe ions of a mixed valence state (Fe²⁺ and Fe³⁺). The Mo 3d spectra of “Paste-0.1M” and “Gel-1M” (FIGS. 8A-B) both showed two peaks at around 232.5 and 235.6 eV, suggesting that the Mo element exists in the gel framework in form of Mo⁶⁺.

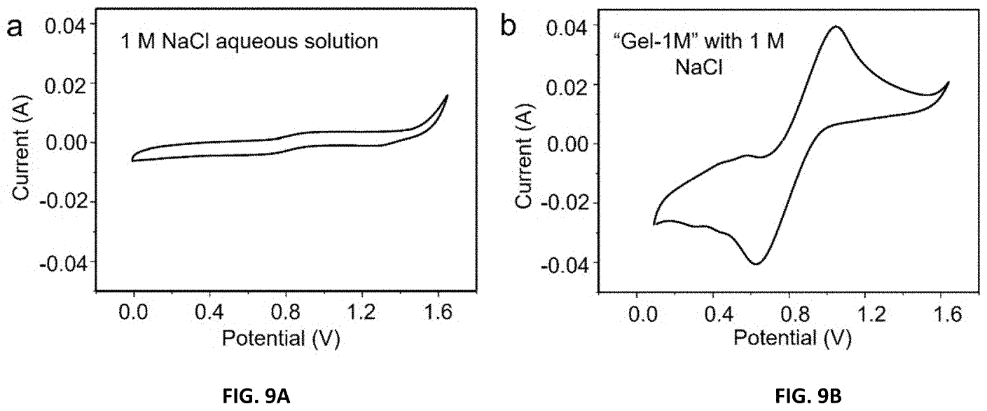

The electrochemical property of the “Gel-1M” with 1M NaCl and pure 1 M NaCl aqueous solution was further investigated by a cyclic voltammetry (CV) curve under a scan rate of 50 mV s⁻¹ in a three-electrode system. The CV curve of “Gel-1M” with 1 M NaCl (FIG. 9B) displayed two small oxidation peaks located at 0.41 and 0.55 V and their corresponding two reduction peaks at 0.28 and 0.42 V, which can be attributed to the redox reaction of H₂MoO₄. Besides, a pair of redox peaks located between 0.6 and 1 V was very remarkable, the strong oxidation peak at 0.98 V was assigned to Fe²⁺ to Fe³⁺, while the reduction peak at 0.66 V was attributed to Fe³⁺ to Fe²⁺, which further confirmed the coexistence of Fe²⁺ and Fe³⁺ in the framework of the mineral hydrogel. For pure 1 M NaCl aqueous solution (FIG. 9A), however, there was no redox activity, only showing a slight double-layer capacitance characteristic.

### Gelation Mechanism

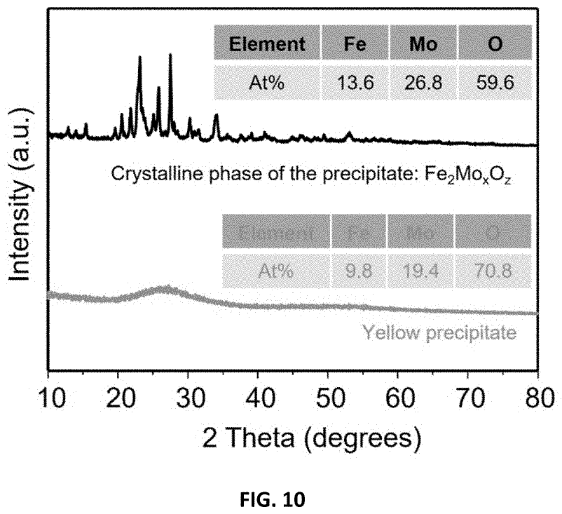

Regarding the gelation mechanism, the yellow precipitates were first observed once the (NH₄)₆Mo₇O₂₄ solution was added to the FeCl₃ solution, possibly produced from the reaction between Fe³⁺ and ammonium molybdate. The yellow precipitates were separated and examined under XRD and EDX (FIG. 10). They appeared to be amorphous and turned into crystalline Fe₂MoₓO_{z} after the thermal treatment (400° C. for 1 hour). Meanwhile, the thermal treatment led to a lower oxygen content, which, considering the presence of hydroxide groups in the paste and gel samples (the XPS results, FIG. 7c), can be attributed to the conversion of hydroxide to oxide. The yellow precipitates are thus assumed to be amorphous iron molybdate hydroxide (FeMo₂Oₓ(OH)_{y}), which gradually dissolves back into the acidic solution under magnetic stiffing and gradually produces a viscous hydrogel by trapping a large amount of water.

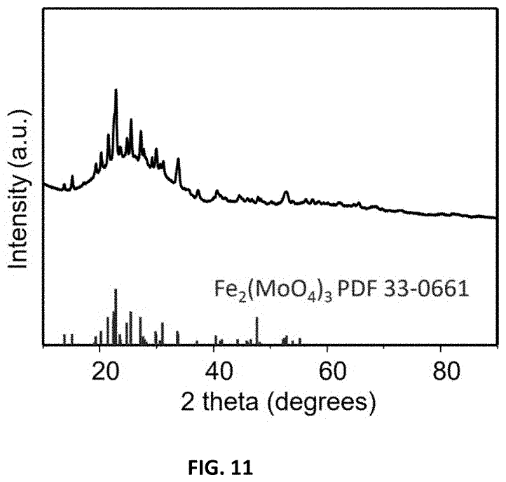

It was found that, among the various metal ions tested (Ni²⁺, Co²⁺, Cu²⁺, Mn²⁺, and Al³⁺), only Fe³⁺ reacts with (NH₄)₆Mo₇O₂₄·4H₂O to produce hydrogels. Note that, different from other metal ions, Fe³⁺ can easily hydrolyze into Fe(OH)₃ precipitates, due to the very low solubility of Fe(OH)₃ (Kₛₚ is 1.1×10⁻³⁴). This fact is regarded to play a key role in the gelation process: at higher concentrations, in addition to Fe³⁺ and MoO₄²⁻ react to produce Fe₂(MoO₄)₃ (FIG. 11), they simultaneously promote each other's hydrolysis to produce Fe(OH)₃ and H₂MoO₄ (formation of H₂MoO₄ verified by the redox peak in the CV curve, FIG. 9B), further forming the yellow precipitates of FeMo₂Oₓ(OH)_{y} (FIG. 10). The reaction process is speculated as follows (eq. 1):

Fe³⁺+MoO₄²⁻+H₂O→FeMo₂Oₓ(OH)_{y}+H₂MoO₄ (1)

Subsequently, FeMo₂Oₓ(OH)_{y} is dissolved back into the solution that contains H₂MoO₄. As both FeMo₂Oₓ(OH)_{y} and H₂MoO₄ possess hydroxyl groups in their structure, hydroxyl bridge are formed to build an interconnected network while trapping water to render a hydrogel. Meanwhile, (NH₄)₂FeCl₅ (FIG. 4) is produced during the gelation process (eq. 2) which absorbs water to further enhance the water storage.

2NH₄⁺+5Cl⁻+Fe³⁺→(NH₄)₂FeCl₅ (2)

However, if (NH₄)₆Mo₇O₂₄·4H₂O was replaced by Na₂MoO₄ or if the solution addition sequence was reversed (i.e., instead of adding (NH₄)₆Mo₇O₂₄ to FeCl₃ but the other way around), no hydrogels but only precipitates in red-brown or yellow, respectively, were obtained. These observations verified that the gelation process is sensitive to pH, and a colloidal solution containing molybdic acid that can dissolve the intermediate precipitate is needed for the gel formation. To sum up, at a suitable pH, FeMo₂Oₓ(OH)_{y} dissolves back into a colloidal solution containing H₂MoO₄ to form continuous nanowire networks, while the salt (NH₄)₂FeCl₅ generated during the gelation process was adsorbed onto their surface to enable higher water storage capacity: an all inorganic mineral hydrogel was thus formed.

### Biocompatibility and Swelling Resistance Study

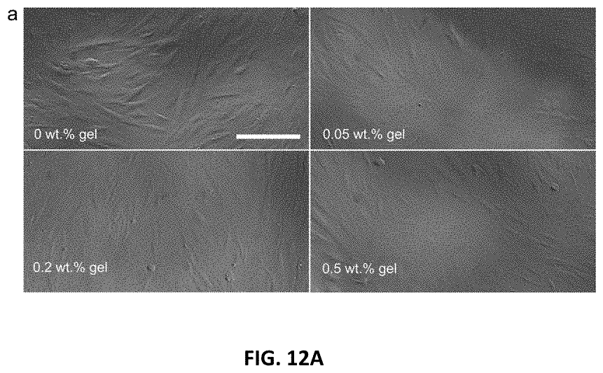

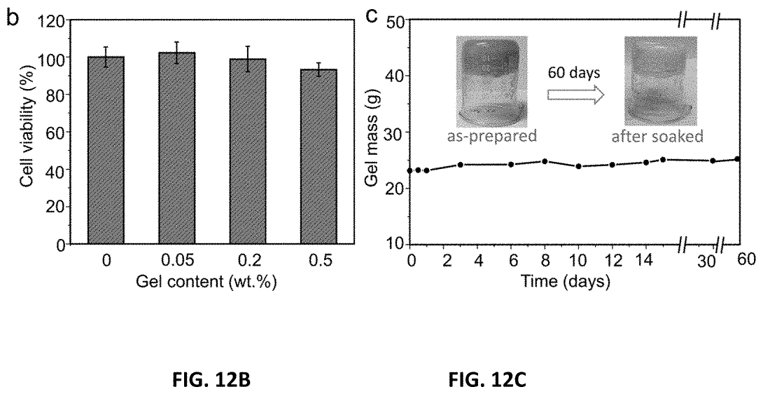

The in vitro cytotoxicity of the mineral hydrogel was investigated by 3-(4,5-dimethylthiazol-2-yl)-2,5-diphenyltetrazolium bromide (MTT) assay using MRC-5 cells (human lung fibroblast). After incubating in media containing different concentrations of gels for 72 h, no morphology changes of MRC-5 cells were observed (FIG. 12A), and the cell viability was high (>93%) even at a strong concentration of 0.5 wt. % (FIG. 12B), highlighting the non-toxicity to human normal cells. Furthermore, the mineral hydrogels reported here are synthesized in a water-based setting with essential elements for life (Fe, Mo). Such excellent biocompatibility stems from its bio-essential components of Fe and Mo, and by its strictly water-based medium.

To investigate the swelling behaviors of the fabricated mineral hydrogels, “Gel-1M” was immersed in water, with the gel mass and dimensions constantly monitored (FIG. 12C). No significant swelling or weight change was induced over 60 days, indicating the strong resistance of the mineral hydrogels against swelling, dispersion, or degradation upon extensive soaking in water.

### Electrochemical Properties and the All-in-One Capacitor

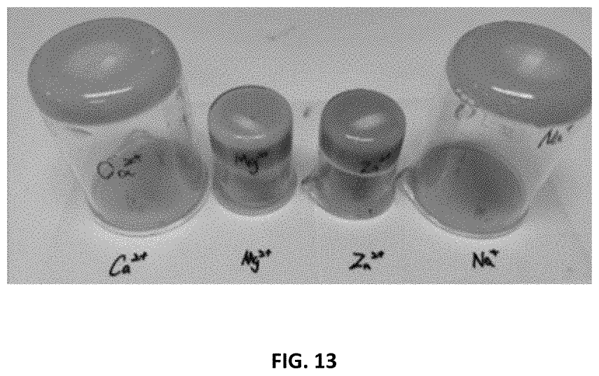

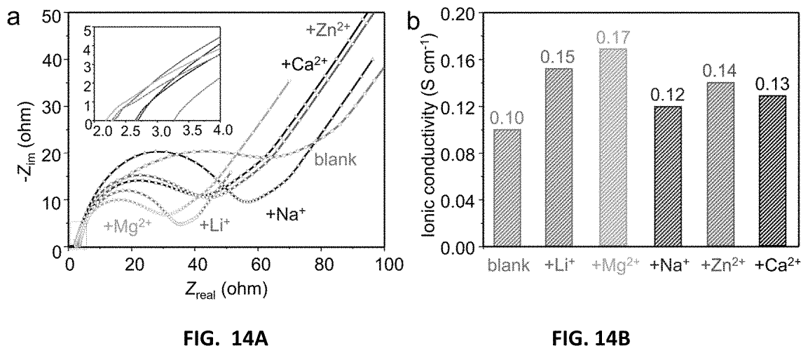

Various metal ionic additives were easily incorporated in the mineral gels by simply mixing the metal salts in the precursor solutions (FIG. 13). This is in sharp contrast with the conventional supramolecular gels, where the inclusion of metal ions is often problematic to induce structural destruction. To evaluate the ionic conduction, the gel itself and cation-incorporated gel were sandwiched between two platinum plates and measured by the electrochemical impedance spectroscopy (EIS) (FIG. 14A). These gels (including the as-made “Gel-1M”) all displayed small interceptions with the real axis, indicating high ion transport capabilities. Based on the magnified image, the ionic conductivities of the as-made “Gel-1M” and “Gel-1M” containing 0.5 M of Li⁺, Mg²⁺, Na⁺, Zn²⁺, or Ca²⁺ were evaluated to be 0.1, 0.15, 0.17, 0.12, 0.14, and 0.13 S cm⁻¹, respectively (FIG. 14B). Because of the native ions in the gel (e.g., Cl⁻, Fe³⁺, NH⁴⁺), the as-made “Gel-1M” already exhibited high ionic conductivity, which was further raised by the added metal salts to outperform most organic gel-based electrolytes (e.g., 0.0078 S cm⁻¹ for CNC/PIL ionogels). Besides, the semicircle in the high-frequency region indicates this to be a gel with redox-active centers; and the metal additives serve to enhance charge transfer, with the semicircles accordingly becoming smaller.

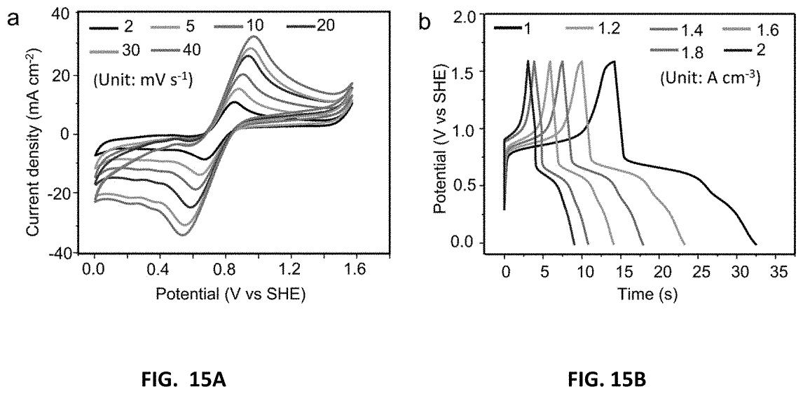

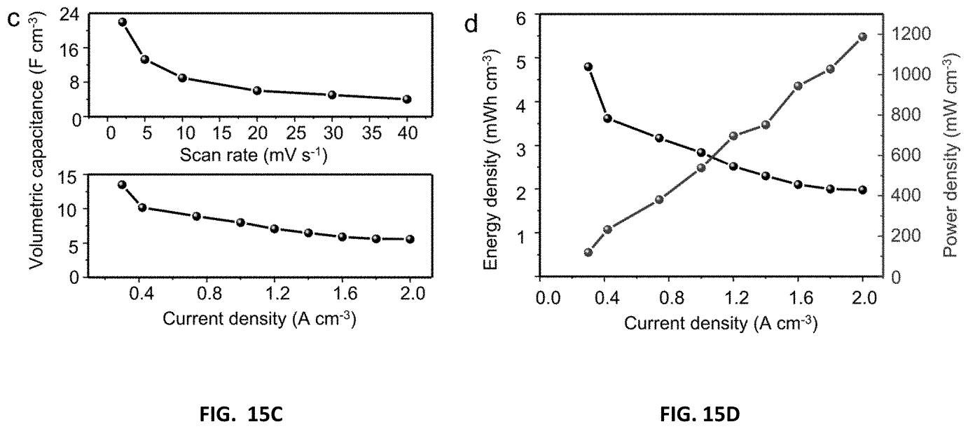

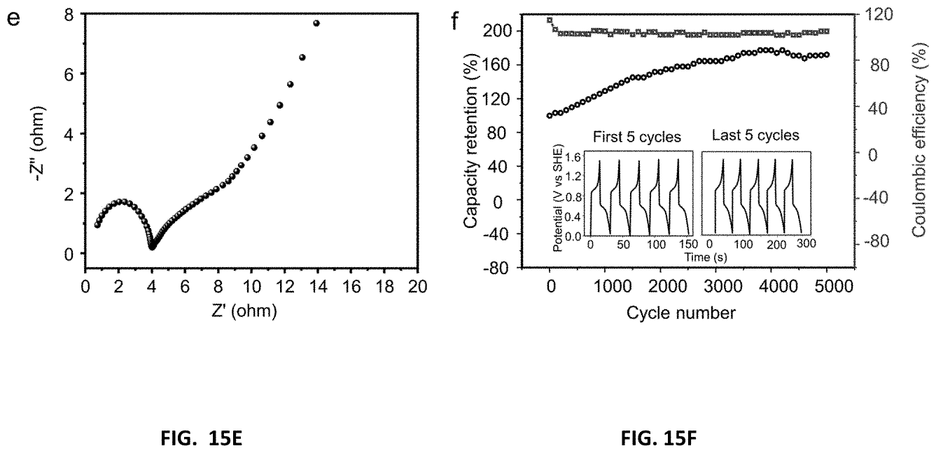

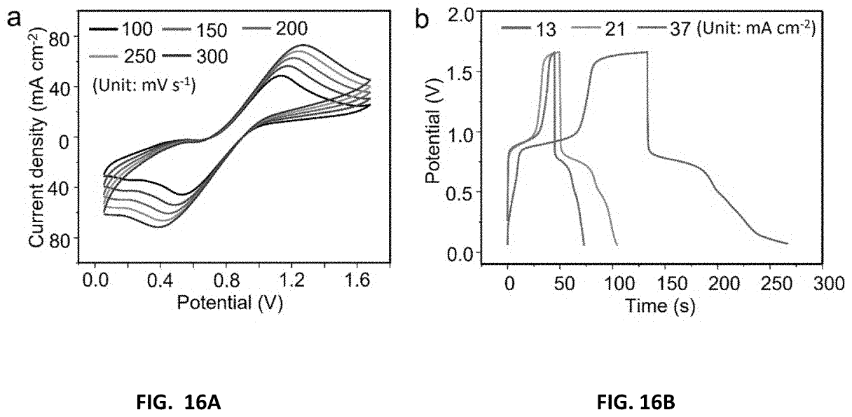

To further investigate the electrochemical performance, the mineral hydrogel was characterized in a three-electrode configuration, where merely two current collectors and a reference electrode were used, i.e., the gel served as the electroactive materials, the electrolyte, and the membrane separator. The cyclic voltammetry (CV), galvanostatic charge/discharge (GCD) and electrochemical impedance spectroscopy (EIS) were measured. From the CV curves (FIG. 15A), the gel exhibited a wide potential window of 1.6 V, and a pair of prominent redox peaks located between 0.6 and 1 V at different scan rates. This highly reversible redox reaction is the major contributor to the gel's capacitance. Furthermore, all the CV curves measured from low to high scan rates (e.g., 300 mV s⁻¹) (FIG. 16A) possessed the similar shape with only slight shift of the oxidation-reduction peaks, indicating the gel's excellent capacitive properties. The GCD curves (FIG. 15C and FIG. 16B) of different current densities between 0 and 1.6 V clearly showed charging and discharging plateaus rather than the triquetrous characteristics, confirming that the charge storage is mainly due to the Faradaic reaction.

The volumetric capacitance and energy density under different scan rates were calculated based on the CV curves (FIG. 15B). This all-in-one mineral hydrogel capacitor exhibited a volumetric capacitance of 22 F cm⁻³ at 2 mV s⁻¹ and a corresponding energy density of 7.8 mWh cm⁻³. The dependence of volumetric capacitance on current densities (FIG. 15D) were calculated from the GCD curves to be 12, 7.4, 6.9, 6.3, 5.6, 5.1, 4.3, 4.2 and 4 F cm⁻³ at 13, 21, 37, 53, 64, 74, 85, 96, and 106 mA cm⁻², respectively, revealing a good rate performance

The EIS plot of the mineral gel from 0.1 to 10⁵ Hz (FIG. 15E) was recorded: in the low-frequency region, the high slope indicated an ideal capacitive behavior with excellent ion transfer capability; in the high-frequency regime, the equivalent series resistance (R_{ESR}), as directly read from the intercept with the real axis, was very low (1Ω), indicating an excellent ionic conductivity of the electrolyte, while the interfacial charge-transfer resistance (R_{ct}) measured from the diameter of the semicircle was small (3Ω), revealing an efficient charge/ion transport at the interface between the electrode material and the electrolyte. This efficient charge/ion transport is attributed to the one-piece holistic design, which perfectly solves the common problem of poor interfacial wettability between electrode and electrolyte.

The mineral hydrogel-based all-in-one supercapacitor also displayed high stability and coulombic efficiency upon repetitive charge/discharge cycles (FIG. 15F). At 46 mA cm⁻², the supercapacitor appeared to first undergo an activation process, whose capacitance kept raising before reaching a stabilized value that corresponded to a retention rate of 160%, while simultaneously maintain an almost perfect coulombic efficiency of 100%.

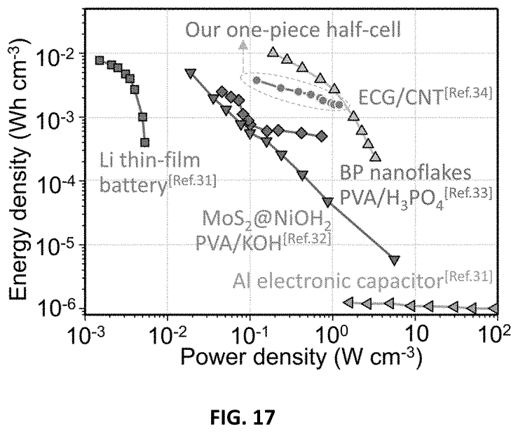

A Ragone plot of our all-in-one mineral hydrogel capacitor was drawn to compare its volumetric energy density and power density with commercial and other reported systems (FIG. 17). For volumetric energy densities, our capacitor features 4.3-1.4 mWh cm⁻³, which compare favorably with a 500-μAh lithium thin-film battery (7.7-0.4 mWh cm⁻³) and is three orders of magnitude that of a 3V/300 mF aluminum electrolytic capacitor (1-1.24×10⁻³ mWh cm⁻³); for power densities, ours delivers 106-853 mW cm⁻³, which is over a hundred times that of the lithium thin-film battery (1.5-5.3 mW cm⁻³). These all-in-one capacitors also compare well with recent devices based on the workhorse materials of MoS₂, black phosphorus, and ECG/CNT.

### INDUSTRIAL APPLICABILITY

A new type of purely inorganic, biocompatible mineral hydrogel has been achieved using a convenient water-based procedure that is low-cost and environmentally friendly. The mineral hydrogels here play two key roles for a capacitor: 1) they readily accommodate a wide range of metal ions and deliver high levels of ionic conductivity; 2) the redox-active center in the gel skeleton endows it with a strong charge storage capacity. A single-component capacitor can therefore be made simply by connecting with two current collectors: the gel in contact with the current collector mainly acts as an active material to provide capacitance, while the gel in middle serves as the electrolyte, affording an all-in-one charge storage device. Besides being low cost, convenient, biocompatible, and environmentally friendly, this holistic approach offers numerous benefits, such as, easy charge transfer between electrode active material and electrolyte, flexible cell designs, and high energy densities. On the other hand, the mineral hydrogel here is biocompatible and can be soaked in water (e.g., for 60 days) without collapse or volume expansion, making it a workable model of the supporting medium in which pre-cells evolved. Moreover, the simple and efficient preparation here points to the possibility of achieving a broader variety of all-inorganic mineral hydrogels.

The mineral hydrogels have many applications as charge storage devices, for biomedical apparatus, and for elucidating the evolution of early life on earth. The mineral hydrogels may be used for electrical applications. These include, but are not limited to, electroactive materials, electrolyte materials, separator membranes, charge storage devices (e.g., batteries or supercapacitors), electrocatalytic materials, photocatalytic materials, electrophoresis materials, filters, sensors, luminescent materials, or magnetic materials.

In another aspect, the mineral hydrogels may be used for medical or biological applications. These include, but are not limited to, adhesive or bonding materials, self-healable materials, tissue-engineering materials, drug delivery materials, drug carriers, cell cultures, or anti-inflammation materials.

The materials of the present invention may also be used in various fabrication applications such as in ink materials for printing ceramics, or in coating or glazing applications.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

1. A method of making an inorganic mineral hydrogel comprising:
providing a first solution including one or more metal cations from one or more inorganic precursors, the metal cations being selected from one or more of Fe, Mg, Ca, Co, Ni, Zn, Ti, Cu, Sn, or Mn;
providing a second solution including one or more polyoxometalates of Mo, W, V, Nb, or Ta;
mixing the first and second solutions to form a mineral hydrogel.

2. The method of claim 1, wherein the polyoxometalate is a heteropolymetalate.

3. The method of claim 1, wherein the polyoxometalate is a quaternary ammonium salt of a polyoxometalate.

4. The method of claim 1, wherein the first and/or second solution is an aqueous solution.

5. The method of claim 4, wherein the first and/or second solution further includes an organic solvent selected from one or more of ethanol, acetone, dimethylformamide, dimethyl sulfoxide, or a carbonate solvent.

6. The method of claim 1, wherein the first or second solution includes a solvent selected from one or more of ethanol, acetone, dimethylformamide, dimethyl sulfoxide, ethylene carbonate, dimethyl carbonate, or diethyl carbonate.

7. The method of claim 1, wherein the second solution includes molybdate, tungstate, chloride, carbonate, phosphate, hydrogen phosphate, hydroxide or acetate anions.

8. The method of claim 1, further comprising drying the hydrogel.

9. The method of claim 1, further comprising adding conductive ions to either the first or second solution prior to mixing.

10. The method of claim 9, wherein the conductive ions are selected from Li⁺, Na⁺, K⁺, Ca²⁺, Mg²⁺, Zn²⁺, Mn²⁺ and mixtures thereof.

11. The method of claim 1, wherein the metal cations in the first solution are from dissolution of a metal salt.

12. The method of claim 11, wherein a ratio of the metal cation in the first solution to a metal component of the quaternary ammonium salt of a polyoxometalate in the second solution to the metal salt in the first solution is from 1:2 to 1:1.

13. A mineral hydrogel made from the process of claim 1.

14. The mineral hydrogel of claim 13, where the mineral hydrogel includes interconnected networks of nanofibers.

15. A supercapacitor including the mineral hydrogel of claim 14.
